(19) United States
(12) Patent Application Publication
(10) Pub. No.: US 2017/0050325 A1
(43) Pub. Date: Feb. 23, 2017

(54) SPRING-ASSISTED KNIFE FOR ENABLING USER TO OPERATE EJECTION AND RECEIVING OF BLADE ON SINGLE LATERAL OF HANDLE

(71) Applicant: KANTAS PRODUCTS CO., LTD., Taipei City (TW)

(72) Inventor: Ming-Tsan LEE, New Taipei City (TW)

(73) Assignee: KANTAS PRODUCTS CO., LTD., Taipei City (TW)

(21) Appl. No.: 14/865,073

(22) Filed: Sep. 25, 2015

(30) Foreign Application Priority Data
Aug. 21, 2015 (TW) 104213550

(51) Int. Cl. B26B 1/08

(52) U.S. Cl. CPC B26B 1/08

(57) ABSTRACT

The present invention is to provide a spring-assisted knife, which includes a handle, a blade movably contained in the handle or exposed out of a front end of the handle, an elastically releasing and receiving assembly disposed inside the handle and movable along the length direction of handle to drive the blade, a releasing key movably mounted on the lateral of handle and capable of being pushed toward the front end of handle for a first predetermined distance for driving the assembly to eject the blade out of the handle, and a receiving key movably exposed out of the lateral of handle and capable of being pushed toward a rear end of the handle for a second predetermined distance for driving the assembly to receive the blade into the handle, so as to enable a user to operate ejection and receiving of the blade at single lateral of the handle.

### FIELD OF THE INVENTION

The present disclosure relates to a knife, more particularly to a spring-assisted knife.

### BACKGROUND OF THE INVENTION

The inventor of the present disclosure designed a spring-assisted knife several years ago, as shown in FIGS. 1 and 2, and the spring-assisted knife includes a knife shell 9, a blade 1, a chute plate 3, a sliding assembly, a blade positioning rod 7 and an auxiliary spring 8. The knife shell 9 is a hollow strip-shaped structure and has a crevice formed at a side thereof and extended along a length direction thereof, and a front opening formed at a front end thereof The blade 1 is slidably disposed in the knife shell 9, and can be ejected out of or received into the knife shell 9 through the front opening. The chute plate 3 is disposed in the knife shell 9 and has a chute 31 formed along a length direction thereof and a positioning slot 10 recessed near a tail end of the chute 31.

Please refer back to FIGS. 1 and 2. The sliding assembly is disposed inside the knife shell 9 and includes a push key plate 2, a sliding block 4, a push key 11, a mounting plate 5 and a positioning plate 6. The push key plate 2 has a protruding part extended out of a side edge of the knife shell 9 through the crevice of the knife shell 9, and a side of the push key plate 2 is combined with a side of the blade 1. The sliding block 4 is slidably disposed in the chute 31 and has a side combined with an opposite side of the push key plate 2. The push key 11 is fixed on the protruding part of the push key plate 2 to facilitate a user's operation by finger. A side of a mounting plate 5 is combined with other side of the sliding block 4. A positioning plate 6 is pivotally connected with an opposite side of the mounting plate 5, and has a hole for inserting of a screw 15 therethrough and a positioning plate support rod 17 protruded from a bottom edge of a rear end of the positioning plate 6 and contained in the positioning slot 10. The blade positioning rod 7 is pivotally connected with a part of the chute plate 3 adjacent to the front opening, and has a hole for inserting of a positioning rod pin 14 therethrough. The mounting plate 5 has an unfilled corner recessed at a top edge thereof, and the blade positioning rod 7 has a groove recessed at a bottom edge thereof, so that the blade positioning rod 7 and the mounting plate 5 can be hooked with each other, and the mounting plate 5 is engaged to prevent the blade 1 from being pushed back to the knife shell 9 while the blade 1 is extended out of the knife shell 9 completely. The chute plate 3 has a spring positioning rod 12 located near the front end thereof, and a front end of the auxiliary spring 8 is mounted on the spring positioning rod 12. The positioning plate 6 has a spring hole formed near the positioning plate support rod 17, and a rear end of the auxiliary spring 8 is mounted into the spring hole.

Please refer back to FIGS. 1 and 2. By means of the structure above-mentioned, in a condition that the blade 1 is contained in the knife shell 9 completely, after the positioning plate support rod 17 is slid into the positioning slot 10, the auxiliary spring 8 applies an elastic force on the positioning plate support rod 17 to locate the positioning plate support rod 17 in the positioning slot 10, so that the blade 1 can be maintained in a status of being received in the knife shell 9. After the positioning plate support rod 17 is pushed to escape from the positioning slot 10, the auxiliary spring 8 applies the elastic force on the positioning plate support rod 17, so that the blade 1 can be ejected out of the knife shell 9. In addition, the spring-assisted knife further has a safety rod 13 pivotally connected on the knife shell 9. The security rod 13 includes a security rod 13 pivotally connected on the knife shell 9. The security rod 13 includes a semicircular pin 13a and a poke part 13b, and the semicircular pin 13a is inserted into the knife shell 9. When the blade 1 is received, the semicircular pin 13a is rotatably engaged in a lock hole la formed a side edge of the blade 1, so as to fix the blade 1. The poke part 13b is extended out of the knife shell 9, and the user can push the poke part 13b to rotate the security rod 13.

However, the inventor finds that it is not convenient for the user to control ejection and receiving of the blade 1 because the blade positioning rod 7 and the push key 11 are protruded and exposed out of different laterals and side edges of the knife shell 9. If the blade positioning rod 7 and the push key 11 are located at the lateral and side edge of the knife shell, where a right-handed user gets used to operate, it is very hard for a left-handed user to operate ejection and receiving of the blade 1 without using two hands, so the convenience of using the knife in emergency condition is greatly reduced for the left-handed user. Therefore, what is need is to design a knife which enables the user to operate the knife by single hand (either right hand or left hand) but not two hands, and use just four fingers to clamp the handle and its side edge and use a thumb to sequentially operate ejection and receiving of the blade on single lateral of the handle, so as to effectively improve convenience of using the knife in an emergency condition.

### SUMMARY OF THE INVENTION

An objective of the present disclosure is to provide a spring-assisted knife which can provide a user to operate ejection and receiving of a blade at single lateral of a handle. The spring-assisted knife includes the blade, the handle, an elastically releasing and receiving assembly, a releasing key and a receiving key. The handle is a hollow strip-shaped structure, and has a guiding hole formed on a lateral thereof along a length direction and near a front end thereof, and a groove recessed at a side edge of the lateral thereof along the length direction. The blade is movably contained in the handle or exposed out of a front end of the handle. The elastically releasing and receiving assembly is disposed inside the handle and movable along the length direction of the handle to push the blade to be ejected out of or received into the handle. The releasing key is movably mounted on the lateral of the handle and movable along the guiding hole. When the releasing key is pushed toward the front end of the handle for a first predetermined distance, the elastically releasing and receiving assembly is driven to eject the blade out of the handle. The receiving key is movably exposed out of the lateral of the handle and movable along the groove. When the receiving key is pushed toward a rear end of the handle for a second predetermined distance, the elastically releasing and receiving assembly is driven to receive the blade into the handle. The second predetermined distance is greater than and parallel to the first predetermined distance. The releasing key and the receiving key both are disposed at the same lateral of the handle, and when the user holds the handle by single hand (either right hand or left hand), the user can just use four fingers to clamp other lateral and its side edge of the handle, and use the thumb to completely operate ejection (pushing the releasing key toward the front end of the handle) or receiving (pushing the receiving key toward the rear end of the handle) of the blade on the same lateral of the handle without using two hands. Therefore, the convenience of using the knife in the emergency condition can be effectively improved.

Other objective of the present disclosure is to provide a handle including a first shell body, a second shell body and at least one division plate. The first shell body defines a first containing space recessed thereon, and a guiding hole is formed along the length direction and located on the lateral of the first shell body and near a front end of the first shell body and in communication with the first containing space. The groove is formed along the length direction and located at a side edge of the lateral of the first shell body. A second shell body defines a second containing space recessed therein and has a front opening formed at a front end thereof and in communication with the second containing space. The blade is movably contained in the second containing space and can be ejected out of or received into the handle through the front opening. The at least one division plate is fastened between the first shell body and the second shell body, and combined with the first shell body and the second shell body to form the handle for being held by the user. The division plate has a chute formed thereon along the length direction, and respectively in communication with the first containing space and the second containing space. A part of a lateral of the division plate corresponding in position to the groove is exposed out of the first shell body.

Another objective of the present disclosure is that the first shell body has a front opening formed at the front end thereof and in communication with the first containing space, and the blade is movably contained in the first containing space and can be ejected out of or received into the handle through the front opening.

Another objective of the present disclosure is that the spring-assisted knife further includes a releasing rod movably contained in the first containing space and has a pushing plate protruded at a rear end thereof. The releasing key is movably mounted on the lateral of the first shell body and connected with a front end of the releasing rod via the guiding hole. When the releasing key is moved along the guiding hole, the releasing rod is driven to move at the same time.

Another objective of the present disclosure is that the elastically releasing and receiving assembly includes a sliding block, a constraint plate, a positioning arm, a releasing spring and a linking plate. The sliding block is slidably disposed in the chute and slidable along a direction of the chute. The constraint plate is fastened at bottom side of the sliding block. The positioning arm has an end pivotally connected on the constraint plate. The releasing spring has an end positioned between the second shell body and the division plate and near a front end of the second shell body, and other end positioned at other end of the positioning arm. In a condition that the blade is received into the handle, the other end of the positioning arm is applied a positioning force by the releasing spring to be located in a positioning slot of the chute disposed near the rear end of the chute, so as to securely position the blade in the handle. The linking plate is fastened on an upper surface of the sliding block, and has a first protruding part protruded thereon and exposed out of the groove. When the pushing plate is pushed forwardly for a first predetermined distance, the other end of the positioning arm is driven to overcome the positioning force to escape from the positioning slot, and the releasing spring then sequentially applies an elastic force on the constraint plate and the sliding block, so that the blade is driven to eject out of the handle through the front opening. The receiving key is fastened with the first protruding part and configured to drive the blade, sequentially via the linking plate, the sliding block and the constraint plate, to be received into the handle through the front opening along a direction of the groove.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is an exploded view of a conventional knife.

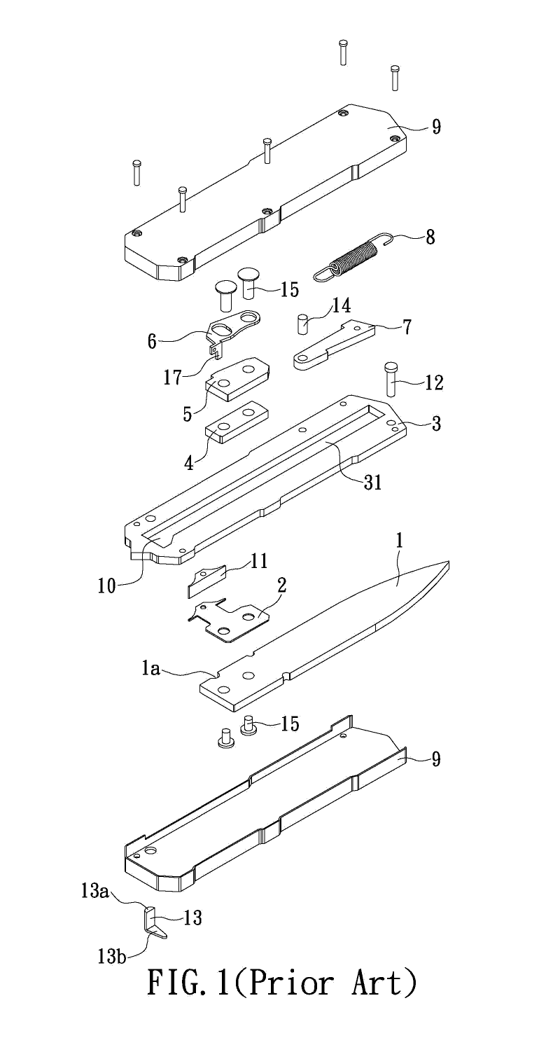

FIG. 2 is an assembly view of a part of the conventional knife.

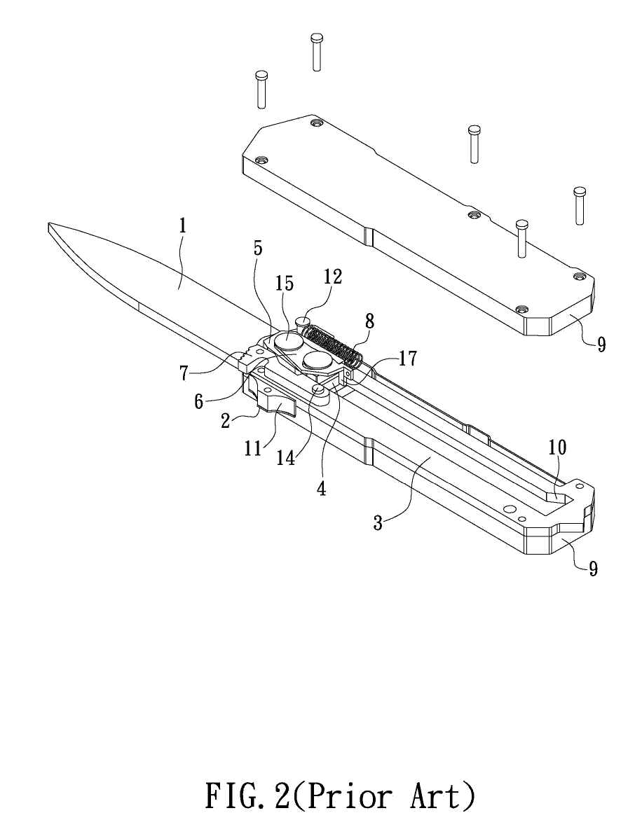

FIG. 3 is an exploded view of a knife of a preferred embodiment of the present disclosure.

FIG. 4 is an assembly view of a knife of other embodiment of the present disclosure.

FIG. 5 is a schematic view of engagement between a locking arm and a constraint plate of the knife of the present disclosure.

FIG. 6 is a schematic view of operation between an unlocking arm, the locking arm and the constraint plate of the knife of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

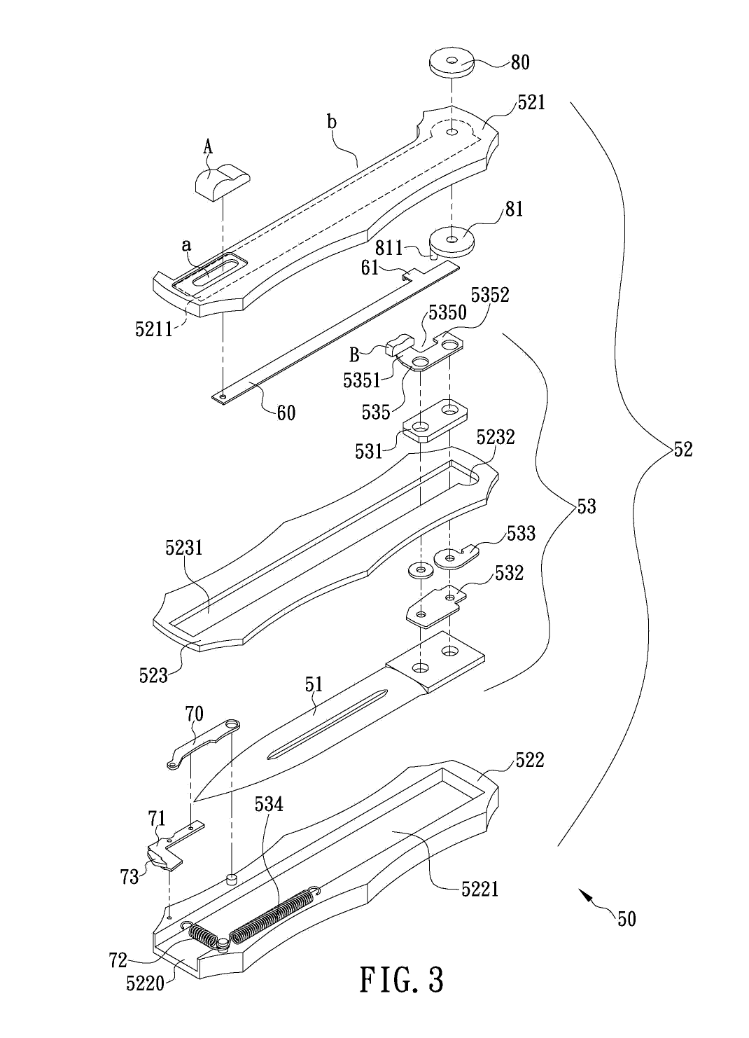

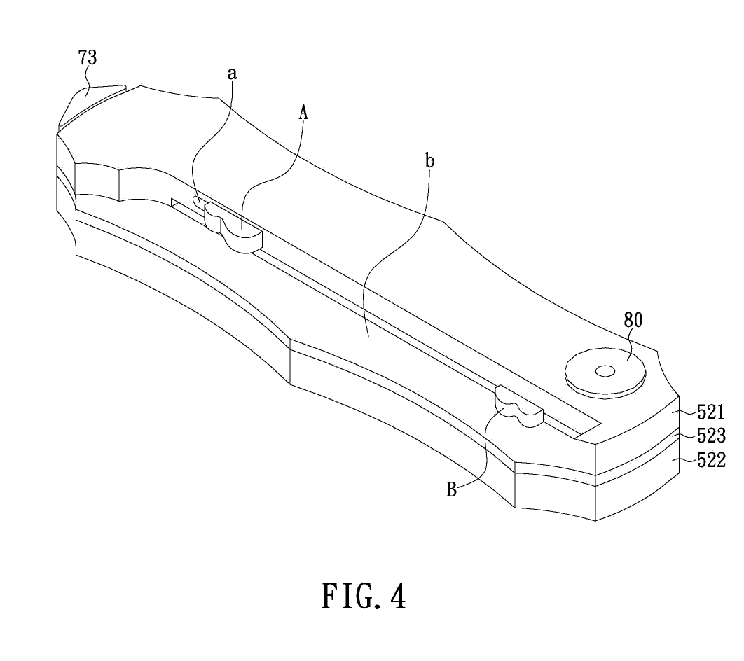

Please refer to FIGS. 3 and 4 which respectively show a preferred embodiment of the present disclosure. In this embodiment, a spring-assisted knife 50 which allows a user to respectively operate ejection and receiving of a blade thereof on single lateral of a handle thereof, includes a blade 51, a handle 52, an elastically releasing and receiving assembly 53, a releasing key A, a receiving key B. The handle 52 is a hollow strip-shaped structure, and has a guiding hole a formed on a lateral thereof and near a front end thereof in a length direction, and a groove b recessed on a side edge of the lateral along the length direction. The blade 51 is movably received in the handle 52 or exposed out of a front end of the handle 52. The elastically releasing and receiving assembly 53 is disposed in the handle 52 and movable along a length direction of the handle 52 to push the blade 51, so as to eject the blade 51 out of the handle 52 or receive the handle 52 into the handle 52. The releasing key A is movably mounted at the lateral of the handle 52 and can be moved along the guiding hole a. When the releasing key A is moved toward the front end for a first predetermined distance, the elastically releasing and receiving assembly 53 is driven to eject the blade 51 out of the handle 52. The receiving key B is movably mounted in the handle 52 and exposed out of the lateral of the handle 52, and can be moved along the groove b. When the receiving key B is moved toward a read end of the handle 52 for a second predetermined distance, the elastically releasing and receiving assembly 53 is driven to receive the blade 51 into the handle 52. The second predetermined distance is greater than the first predetermined distance, and the second predetermined distance is parallel to the first predetermined distance.

Please refer back to FIGS. 3 and 4. The releasing key A and the receiving key B both are disposed on the lateral of the handle 52 (such as the wider lateral shown in FIG. 3 or the narrower lateral shown in FIG. 4) and exposed out of the lateral. While the user holds the handle 52 by single hand (either right hand or left hand), the user can clamp an opposite lateral of the handle 52 and its side edge by just four fingers and operate ejection and receiving of the blade 51 by using the thumb to sequentially poke the releasing key A (such as pushing the releasing key A toward the front end of the handle 52) and the receiving key B (such as pushing the receiving key B toward the back end of the handle 52) which are arranged at the same lateral. Therefore, the user can operate the knife 50 without using two hands, and convenience of using the knife 50 in an emergency situation can be effectively improved.

Please refer back to FIGS. 3 and 4. Upon practical demand, the structure of the handle 52 can be designed to include a first shell body 521, a second shell body 522 and at least one division plate 523. The first shell body 521 defines a first containing space 5211 recessed thereon, and the guiding hole a is formed on a lateral thereof, near the front end thereof and along the length direction thereof, and in communication with the first containing space 5211. The groove b is formed on a side edge of the lateral of the first shell body 521. The second shell body 522 defines a second containing space 5221 recessed thereon, and has a front opening 5220 formed at a front end thereof and in communication with the second containing space 5221. The blade 51 is movably contained in the second containing space 5221, and can be ejected out of or received into the handle 52 through the front opening 5220. The division plate 523 is fastened between and combined with the first shell body 521 and the second shell body 522 to form the handle 52 for being held by the user. The division plate 523 has a chute 5231 cut therethrough along the length direction and in communication with the first containing space 5211 and the second containing space 5221 both. A part of a lateral of the division plate 523 corresponding in position to the groove b is exposed out of the lateral of the first shell body 521. In other embodiment of the present disclosure, upon practical demand, the front opening can be designed at the front end of the first shell body and in communication with the first containing space, the blade can be movably contained in the first containing space and operated to eject out of or receive into the handle through the front opening.

Please refer back to FIG. 3. In aforesaid embodiment, the spring-assisted knife 50 can further includes a releasing rod 60 which is movably contained in the first containing space 5211 and has a pushing plate 61 protruded at a rear end of the releasing rod 60. The releasing key A is movably mounted on the lateral of the first shell body 521 and connected with the front end of the releasing rod 60 through the guiding hole a, so that the releasing rod 60 can be driven to move by the movement of the releasing key A along the guiding hole a. In addition, as shown in FIG. 3, the elastically releasing and receiving assembly 53 includes a sliding block 531, a constraint plate 532, a positioning arm 533, a releasing spring 534 and a linking plate 535. The sliding block 531 is slidably disposed in the chute 5231 and slidable along the chute 5231. The constraint plate 532 is fastened at a bottom side of the sliding block 531. An end of the positioning arm 533 is pivotally connected on the constraint plate 532. The releasing spring 534 has an end positioned between the shell body 522 and the division plate 523 and near the front end of the second shell body 522, and other end positioned at other end of the positioning arm 533. In a condition that the blade 51 is received into the handle 52, the other end of the positioning arm 533 is located in a positioning slot 5232 near the rear end of the chute 5231 subject to a positioning force applied by the releasing spring 534, so that the blade 51 can be securely positioned in the handle 52. The linking plate 535 is fixed on an upper surface of the sliding block 531, and has a first protruding part 5351 protruded thereon and exposed out of the groove b. When the push plate 61 is pushed toward the front end for the first predetermined distance, the linking plate 535 is forced to move toward the front end and then drive the sliding block 531 and the constraint plate 532 to move toward the front end at the same time, so that other end of the positioning arm 533 can overcome the positioning force to escape from the positioning slot 5232. At this time, the releasing spring 534 applies a releasing force to the constraint plate 532 and the sliding block 531 sequentially, so that the blade 51 is driven to eject out of the handle 52 through the front opening 5220. The receiving key B is fastened with the first protruding part 5351 and can be moved along a direction of the groove b to drive the blade 51 through the linking plate 535, the sliding block 531 and the constraint plate 532 sequentially, so as to enable the blade 51 to be received into the handle 52 through the front opening 5220.

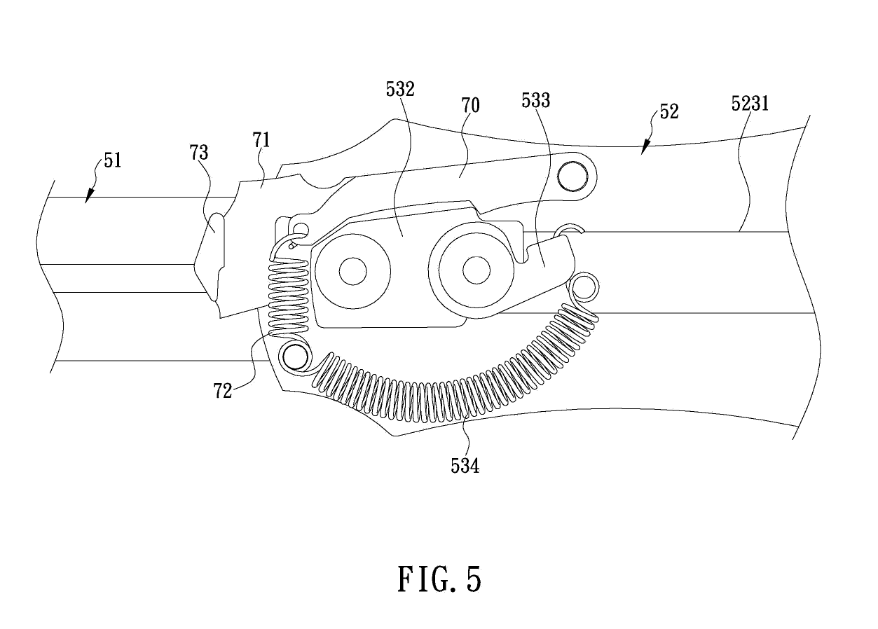

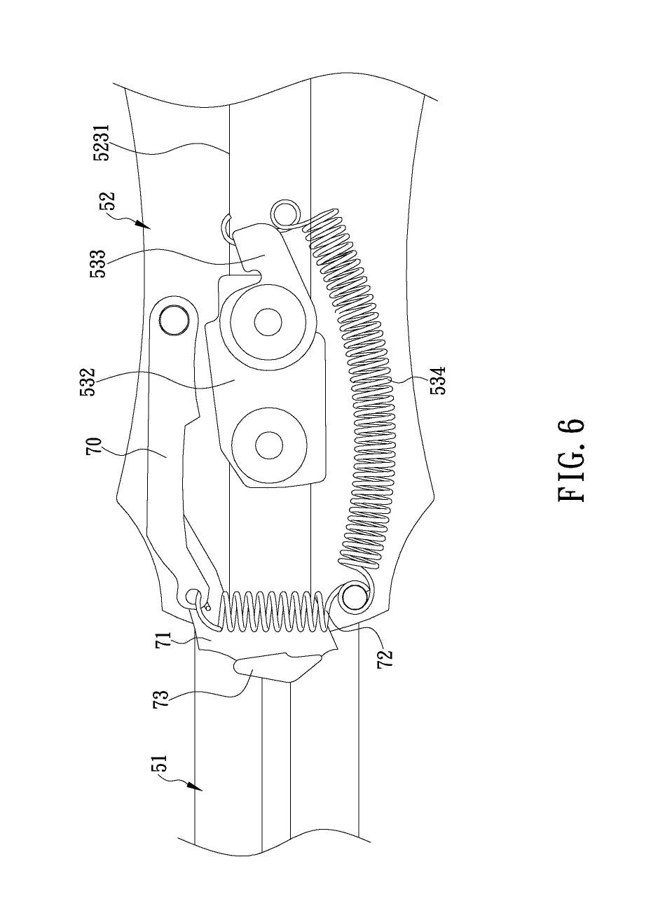

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure. Please refer to FIGS. 5 and 6. In other embodiment of the present disclosure, upon practical demand, the spring-assisted knife 50 can further includes a locking arm 70 which has an end pivotally connected between the second shell body 522 and the division plate 523 and located near the front opening 5220. When the blade 51 is ejected out of the handle 52 completely, the constraint plate 532 is engaged with the locking arm 70 to avoid the blade 51 from being pushed back to the handle 52, as shown in FIG. 5. Please refer back to FIGS. 3 through 6. The spring-assisted knife 50 can further include an unlocking arm 71, an unlocking spring 72 and an unlocking key 73. The unlocking arm 71 has an end pivotally connected with a middle section of the locking arm 70, and a middle section pivotally connected between the second shell body 522 and the division plate 523 and located near the front opening 5220. The unlocking spring 72 has an end positioned between the second shell body 522 and the division plate 523 and near the front opening 5220, and an opposite end positioned at an opposite end of the unlocking arm 71, so that the locking arm 70 is in a status of able to be engaged with the constraint plate 532. The unlocking key 73 is exposed out of the front end of the handle 52, and fastened at the opposite end of the unlocking arm 71. When the user pushes the unlocking key 73, the unlocking arm 71 is driven to move the locking arm 70 to escape from the constraint plate 532, that is, the engagement between the locking arm 70 and the constraint plate 532 is released. Please refer back to FIG. 5. In a condition that the blade 51 is ejected out of the handle 52, the user can just hold the handle 52 by single hand (either right hand or left hand), and the user's four fingers clamp the opposite lateral of the handle 52 and its side edge and the user's thumb can poke the unlocking key 73 to move the locking arm 70 to enable the locking arm 70 to escape from the engagement with the constraint plate 532, as shown in FIG. 6, and the user's thumb then pokes the receiving key B toward the rear end of the handle 52. Therefore, the user can respectively operate the unlocking action (poking the unlocking key 73) and receiving action (poking the receiving key B toward the rear end of the handle 52) of the blade 51 at the same lateral of the handle 52 without using dual hands, thereby completing the unlocking and receiving operations of the blade 51 smoothly and quickly.

Please refer back to FIG. 3. In other embodiment of the present disclosure, upon practical demand the linking plate 535 can further has a second protruding part 5352 disposed near a rear end thereof The second protruding part 5352 is spaced apart from the first protruding part 5351 by a predetermined separation space 5350. The spring-assisted knife 50 further includes a safety button 80 and a safety constraint member 81. The safety button 80 is pivoted at the lateral of the first shell body 521 and near the rear end of the first shell body 521. The safety constraint member 81 is disposed between the first shell body 521 and the division plate 523 and near the rear end of the first shell body 521, and connected with the safety button 80. The safety constraint member 81 can be rotated following the rotation of the safety button 80, to move a fastener 811 of the safety constraint member 81 to enter into or escape from the predetermined separation space 5350. Therefore, in the condition that the blade 51 is received in the handle 52 and the user does not want to use the knife 50, the user can just hold the handle 52 by single hand (either right hand or left hand), the user's four fingers clamp the opposite lateral of the handle 52 and its side edge, and the user's thumb pokes the safety button 80 to enable the safety constraint member 81 to rotate following the rotation of the safety button 80, so that the fastener 811 can be moved into the predetermined separation space 5350 to ensure that the releasing key cannot be pushed forwardly for the first predetermined distance, and it can further effectively prevent the blade 51 from accidentally being ejected out of the handle because of the releasing key A being touched carelessly. When wanting to use the knife 50, the user can just hold the handle 52 by single hand (either right hand or left hand), and use the thumb to poke the safety button 80 to enable the safety constraint member 81 to rotate following the rotation of the safety button 80, so that the fastening 811 can be escaped from the predetermined separation space 5350; and, the user then uses the thumb pushes the releasing key A toward the front end of the handle 52, so that the user can eject the blade 51 out of the handle 52 conveniently and quickly.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A spring-assisted knife for enabling a user to operate ejection and receiving of a blade at the same lateral of a handle, the spring-assisted knife comprising:
the handle, being a hollow strip-shaped structure and having a guiding hole formed on a lateral thereof along a length direction thereof and near a front end thereof, and a groove recessed at a side edge of the lateral thereof along the length direction;
the blade, movably received in the handle or exposed out of the front end of the handle;
an elastically releasing and receiving assembly, disposed inside the handle and movable along the length direction of the handle to push the blade to eject the blade out of or receive the blade into the handle;
a releasing key, movably mounted on the lateral of the handle and movable along the guiding hole, wherein when the releasing key is pushed toward the front end of the handle for a first predetermined distance, the elastically releasing and receiving assembly is driven to eject the blade out of the handle; and
a receiving key, movably mounted on and exposed out of the lateral of the handle and movable along the groove, wherein when the receiving key is pushed toward a rear end of the handle for a second predetermined distance, the elastically releasing and receiving assembly is driven to receive the blade into the handle, and the second predetermined distance is greater than and parallel to the first predetermined distance.

2. The spring-assisted knife according to claim 1, wherein the handle comprises:
a first shell body, defining a first containing space recessed thereon, the guiding hole formed along the length direction and located on a lateral of the first shell body near a front end of the first shell body and in communication with the first containing space, and the groove formed along the length direction and on a side edge of the lateral of the first shell body;
a second shell body, defining a second containing space recessed thereon, and having a front opening formed at a front end thereof and in communication with the second containing space, and the blade movably contained in the second containing space and selectively ejected out of or received into the handle through the front opening; and
at least one division plate, fastened between the first shell body and the second shell body, and combined with the first shell body and the second shell body to form the handle for being held by the user, the at least one division plate having a chute cut therethrough along the length direction and respectively in communication with the first containing space and the second containing space, and wherein a lateral of the division plate corresponding in position to the groove is exposed out of the first shell body.

3. The spring-assisted knife according to claim 1, wherein the handle comprises:
a first shell body, defining a first containing space recessed thereon, and has a front opening formed at front end thereof and in communication with the first containing space, wherein the blade is movably contained in the first containing space and selectively ejected out of or received into the handle, the guiding hole is formed on a lateral of the first shell body along the length direction, near the front end of the first shell body and in communication with the containing space, and the groove is formed along the length direction at a side edge of the lateral of the first shell body;
a second shell body, defining a second containing space recessed thereon; and
at least one division plate, fastened between the first shell body and the second shell body and combined with the first shell body and the second shell body to form the handle for being held by the user, wherein the division plate has a chute cut therethrough along the length direction and in communication with the first containing space and the second containing space, and a part of a side of the division plate corresponding in position to the groove is exposed out of the first shell body.

4. The spring-assisted knife according to claim 2, further comprising a releasing rod movably contained in the first containing space and having a pushing plate protruded at a rear end thereof;
wherein the releasing key is movably mounted on the lateral of the first shell body and connected with a front end of the releasing rod via the guiding hole, and when the releasing key is moved along the guiding hole, the releasing rod is driven to move at the same time.

5. The spring-assisted knife according to claim 3, further comprising a releasing rod movably contained in the first containing space and having a pushing plate protruded at a rear end thereof;
wherein the releasing key is movably mounted on the lateral of the first shell body and connected with a front end of the releasing rod via the guiding hole, and when the releasing key is moved along the guiding hole, the releasing rod is driven to move at the same time.

6. The spring-assisted knife according to claim 4, wherein the elastically releasing and receiving assembly comprises:
a sliding block, slidably disposed in the chute and slidable along the chute;
a constraint plate, fastened at a bottom side of the sliding block;
a positioning arm, having an end pivotally connected on the constraint plate;
a releasing spring, having an end positioned between the second shell body and the division plate and near a front end of the second shell body, and an opposite end positioned at an opposite end of the positioning arm, wherein in a condition that the blade is received into the handle, the opposite end of the positioning arm is applied a positioning force by the releasing spring to locate in a positioning slot of the chute disposed near the rear end of the chute, so as to securely position the blade in the handle; and
a linking plate, fastened on an upper surface of the sliding block, having a first protruding part protruded thereon and exposed out of the groove, wherein when the pushing plate is pushed forwardly for a first predetermined distance, the linking plate drives the opposite end of the positioning arm to overcome the positioning force to escape from the positioning slot, and the releasing spring sequentially applies a releasing force on the constraint plate and the sliding block, so that the blade is driven to eject out of the handle through the front opening;
wherein the receiving key is fastened with the first protruding part and configured to drive the blade, via the linking plate, the sliding block and the constraint plate sequentially, to be received into the handle through the front opening along a direction of the groove.

7. The spring-assisted knife according to claim 5, wherein the elastically releasing and receiving assembly comprises:
a sliding block, slidably disposed in the chute and slidable along the chute;
a constraint plate, fastened at a bottom side of the sliding block;
a positioning arm, having an end pivotally connected on the constraint plate;
a releasing spring, having an end positioned between the second shell body and the division plate and near a front end of the second shell body, and an opposite end positioned at an opposite end of the positioning arm, wherein in a condition that the blade is received into the handle, the opposite end of the positioning arm is applied a positioning force by the releasing spring to locate in a positioning slot of the chute disposed near the rear end of the chute, so as to securely position the blade in the handle; and
a linking plate, fastened on an upper surface of the sliding block, having a first protruding part protruded thereon and exposed out of the groove, wherein when the pushing plate is pushed forwardly for a first predetermined distance, the linking plate drives the opposite end of the positioning arm to overcome the positioning force to escape from the positioning slot, and the releasing spring sequentially applies a releasing force on the constraint plate and the sliding block, so that the blade is driven to eject out of the handle through the front opening;
wherein the receiving key is fastened with the first protruding part and configured to drive the blade, via the linking plate, the sliding block and the constraint plate sequentially, to be received into the handle through the front opening along a direction of the groove.

8. The spring-assisted knife according to claim 6, further comprising:
a locking arm having an end pivotally connected with a location between the second shell body and the division plate and near the front opening, wherein when the blade is completely ejected out of the handle, the locking arm is engaged with the constraint plate to prevent the blade from being pushed back to the handle.

9. The spring-assisted knife according to claim 7, further comprising:
a locking arm having an end pivotally connected with a location between the second shell body and the division plate and near the front opening, wherein when the blade is completely ejected out of the handle, the locking arm is engaged with the constraint plate to prevent the blade from being pushed back to the handle.

10. The spring-assisted knife according to claim 8, further comprising:
an unlocking arm, having an end pivotally connected with a middle section of the locking arm, and a middle section pivotally connected with a location between the second shell body and the division plate and near the front opening;
an unlocking spring, having an end positioned at a location between the second shell body and the division plate and near the front opening, and an opposite end positioned at an opposite end of the unlocking arm;
an unlocking key, exposed out of the front end of the handle, and fastened at the opposite end of the unlocking arm, wherein when the user pushes the unlocking key, the locking arm is driven by the unlocking arm to escape from the engagement with the constraint plate.

11. The spring-assisted knife according to claim 9, further comprising:
an unlocking arm, having an end pivotally connected with a middle section of the locking arm, and a middle section pivotally connected with a location between the second shell body and the division plate and near the front opening;
an unlocking spring, having an end positioned at a location between the second shell body and the division plate and near the front opening, and an opposite end positioned at an opposite end of the unlocking arm;
an unlocking key, exposed out of the front end of the handle, and fastened at the opposite end of the unlocking arm, wherein when the user pushes the unlocking key, the locking arm is driven by the unlocking arm to escape from the engagement with the constraint plate.

12. The spring-assisted knife according to claim 10, wherein the linking plate further has a second protruding part protruded near a rear end thereof, and the second protruding part is spaced apart from the first protruding part by a predetermined separation space, and the spring-assisted knife further comprising:
a safety button, pivoted on the lateral of the first shell body and near the rear end of the first shell body; and
a safety constraint member, disposed between the first shell body and the division plate and near the rear end of the first shell body, and connected with the safety button, wherein a fastener of the safety constraint member is rotatable following the rotation of the safety button to enter into or escape from the predetermined separation space.

13. The spring-assisted knife according to claim 11, wherein the linking plate further has a second protruding part protruded near a rear end thereof, and the second protruding part is spaced apart from the first protruding part by a predetermined separation space, and the spring-assisted knife further comprising:
a safety button, pivoted on the lateral of the first shell body and near the rear end of the first shell body; and
a safety constraint member, disposed between the first shell body and the division plate and near the rear end of the first shell body, and connected with the safety button, wherein a fastener of the safety constraint member is rotatable following the rotation of the safety button to enter into or escape from the predetermined separation space.
